(19) United States
(12) Patent Application Publication
(10) Pub. No.: US 2018/0225648 A1
(43) Pub. Date: Aug. 9, 2018

(54) Variable Payment Scheduling Method and System

(71) Applicant: Earned LLC, Longmont, CO (US)

(72) Inventors: Timothy L. Robinson, Alexandria, VA (US); Bradford R. Schildt, Longmont, CO (US)

(73) Assignee: Earned LLC, Longmont, CO (US)

(21) Appl. No.: 15/852,745

(22) Filed: Dec. 22, 2017

Related U.S. Application Data
(60) Provisional application No. 62/454,529, filed on Feb. 3, 2017.

(51) Int. Cl. G06Q 20/24; G06Q 20/26; G06Q 40/02

(52) U.S. Cl. CPC G06Q 20/24; G06Q 40/025; G06Q 20/26

(57) ABSTRACT

A method is provided. The method includes one or more of receiving, from a merchant device, information about a purchase transaction by a consumer, calculating, by a credit server, a plurality of payment times comprising an immediate payment time and a later payment time, transmitting, to a client device, the plurality of payment times, selecting a payment time of the plurality of payment times, receiving, by the credit server, the selected payment time, scheduling, by the credit server, processing of the purchase transaction at the selected payment time, and processing the purchase transaction at the selected payment time.

### CROSS REFERENCE TO RELATED APPLICATIONS

This application claims priority to earlier filed provisional application No. 62/454,529 filed Feb. 3, 2017, entitled “A SYSTEM AND METHOD FOR CONSUMER CHOICE FOR PAYMENT PROCESSING OF FINANCIAL TRANSACTIONS”, the entire contents of which are hereby incorporated by reference.

### FIELD

The present invention is directed to methods and systems for scheduling purchase payments at variable payment times.

### BACKGROUND

Credit cards are a familiar vehicle for making purchases. This high-interest credit facility provides qualified consumers with an incentive to accelerate purchase decisions on various products and services. In effect, the high-interest credit facility enables consumers to increase purchase amounts as well as the frequency of purchases. Merchants clearly benefit through the increase in the average size of sales as well as the overall amount of sales to particular consumers. As is well known, the high interest rates and substantial late fees associated with credit cards are for consumers a significant drawback to the use of credit cards. Additionally, many consumers do not qualify for credit issuance and therefore may not be able to use credit cards to increase purchase amounts or make purchases without a positive balance in their financial account.

### SUMMARY

The present invention is directed to solving disadvantages of the prior art. In accordance with embodiments of the present invention, a method is provided. The method includes one or more of receiving, from a merchant device, information about a purchase transaction by a consumer, calculating, by a credit server, a plurality of payment times comprising an immediate payment time and a later payment time, transmitting, to a client device, the plurality of payment times, selecting a payment time of the plurality of payment times, receiving, by the credit server, the selected payment time, scheduling, by the credit server, processing of the purchase transaction at the selected payment time, and processing the purchase transaction at the selected payment time.

In accordance with another embodiment of the present invention, a system is provided. The system includes a network, a merchant device, a credit server, and a client device. Each of the merchant device, credit server, and the client device are coupled to the network. The merchant device is configured to perform a purchase transaction for a consumer. The credit server is configured to one or more of receive information about the purchase transaction from the merchant device, calculate a plurality of payment times comprising an immediate payment time and a maximum payment time, transmit the plurality of payment times, receive a selected payment time, schedule processing of the purchase transaction at the selected payment time, and process the purchase transaction at the selected payment time. The client device is configured to one or more of receive the plurality of payment times, present the plurality of payment times to the consumer, identify the selected payment time of the plurality of payment times, and transmit the selected payment time.

In accordance with yet another embodiment of the present invention, a non-transitory computer readable storage medium is provided. The non-transitory computer readable storage medium includes one or more of receiving, from a merchant device, information about a purchase transaction by a consumer, the information comprising at least a purchase amount and a purchase date, calculating, by a credit server, a plurality of payment times comprising an immediate payment time and a later payment time, transmitting, to a client device, the plurality of payment times, selecting a payment time of the plurality of payment times, receiving, by the credit server, the selected payment time, scheduling processing of the purchase transaction at the selected payment time, and processing the purchase transaction at the selected payment time.

One advantage of the present invention is that it provides opportunities for consumers to schedule payments for purchase transactions based on their own knowledge of their financial situation and cash flow. Traditionally, payments are either made immediately or on a statement due date for a previous statement period. The present application allows consumers to specify anywhere from a standard processing payment time to a maximum payment date—often with intermediate payment dates available as well.

Another advantage of the present invention is that it provides variable transaction fees associated with payment dates. In many cases, earlier payment dates will have lower and possibly no transaction fees, while later payment dates will have higher transaction fees. This incentivizes consumers to select earlier payment times, thus avoiding late payments and possibly improving the consumer's credit score.

Another advantage of the present invention is it benefits merchants by providing increased sales from a large group of consumers who otherwise would not be customers. Without the present invention, consumers may not have funds in a bank to pay for needed items prior to the next payday. The present invention allows consumers to make purchases when needed, resulting in increased revenue for merchants and increased flexibility for consumers.

Another advantage of the present invention is that it reduces consumer overdraft fees by allowing purchase transactions that exceed a consumer's bank account balance without overdraft fees.

Additional features and advantages of embodiments of the present invention will become more readily apparent from the following description, particularly when taken together with the accompanying drawings. This overview is provided to introduce a selection of concepts in a simplified form that are further described below in the detailed description. It may be understood that this overview is not intended to identify key features or essential features of the claimed subject matter, nor is it intended to be used to limit the scope of the claimed subject matter.

### BRIEF DESCRIPTION OF THE DRAWINGS

FIG. 1 is a diagram illustrating a Data Communication Network in accordance with embodiments of the present invention.

FIG. 2 is a block diagram illustrating a Server in accordance with embodiments of the present invention.

FIG. 3 is a block diagram illustrating a Server in accordance with embodiments of the present invention.

FIG. 4 is a diagram illustrating Parameters used to Configure Payment Times in accordance with embodiments of the present invention.

FIG. 5 is a flow diagram illustrating a Transaction using a Combined Credit/Banking Server in accordance with embodiments of the present invention.

FIG. 6 is a flow diagram illustrating a Transaction using Separate Credit and Banking Servers in accordance with embodiments of the present invention.

FIG. 7 is a flowchart illustrating a Combined Credit/Banking Server Transaction Process in accordance with embodiments of the present invention.

FIG. 8 is a flowchart illustrating a Separate Credit and Banking Server Transaction Process in accordance with embodiments of the present invention.

FIG. 9 is a flowchart illustrating a Combined Credit/Banking Server Transaction Process in accordance with embodiments of the present invention.

FIG. 10 is a flowchart illustrating a Separate Credit and Banking Server Transaction Process in accordance with embodiments of the present invention.

FIG. 11 is a flowchart illustrating a Combined Credit/Banking Server Transaction Process in accordance with embodiments of the present invention.

FIG. 12 is a flowchart illustrating a Maximum Payment Time Calculation Process in accordance with embodiments of the present invention.

FIG. 13 is a diagram illustrating a User Interface Payment Time Selection Window in accordance with embodiments of the present invention.

FIG. 14 is a diagram illustrating a User Interface Additional Offers Window in accordance with embodiments of the present invention.

### DETAILED DESCRIPTION

The present invention provides the ability for consumers to schedule the payment date for previous purchase transactions. In accordance with the present invention, a new payment vehicle is provided which allows consumers and merchants to effectuate transactions that are not currently available to a large group of consumers. This new payment vehicle benefits consumers by providing a choice for when to pay for previous merchant transactions. For consumers with balances on credit cards, interest is charged from the date of the transaction. By conveniently allowing consumers to pay for purchase transactions with a card linked to a checking account before a payday, consumers save money by reducing interest payments on other cards and avoiding overdraft fees on their checking account.

In one embodiment, the consumer's payment vehicle is a VISA credit card issued by a first bank. In additional embodiments, the payment vehicle may be one or more of a hybrid credit/debit card, debit card, prepaid card, ACH card, virtual credit card, virtual debit card, virtual prepaid card, virtual ACH card, checking account, savings account, money market account, and mobile device account. In addition to the standard consumer agreement, the consumer signs an addendum that authorizes a credit server, for each transaction, to send a debit to the consumer's third-party bank account after the time period chosen by the consumer. While any transaction would be processed to the VISA credit card issued by the first bank, the actual payment processing of the transaction would be debited from the consumer's third party bank account. In an additional embodiment, the consumer acknowledges that a transaction fee may be charged to the consumer's third-party bank account for each transaction, determined by a fee schedule.

While merchants benefit from accelerated purchase decisions by consumers, the existing credit vehicles are not available to a significant portion of their customers, and many customers with credit cards do not want to use them and potentially incur additional debt. Additionally, for consumers with balances on credit cards, interest is charged from the date of the transaction. Yet employees do not receive interest on their accrued payroll while effectively financing their employer. These customers frequently use debit cards, which deduct the transaction amount from a positive balance checking account at the time of the transaction, or at the end of the business day. Debit card customers are unable to make purchases at merchants when their account balances are not positive. For the 76% of the US population that lives paycheck to paycheck and 47% that cannot make a $400 emergency payment, the time period immediately preceding a payday is one in which they can make no purchases at merchants.

Prior to the widespread use of debit cards, and electronic processing of checks, consumers would make payments by check on a checking account without a positive balance, knowing the check would not clear for a few days. This “float” provided consumers with a few days of credit, prior to their payday. Over the last 20 years, consumer “float” has effectively been removed from the current payment systems to the detriment of consumers and merchants. In addition, issuing banks of both credit and debit cards earn interchange for each transaction made by the consumer. In some cases, consumers are rewarded with a portion of this interchange, while in others, no benefit is paid to the consumer. Employers typically pay their employees biweekly, or monthly in arrears, effectively creating a system where employees finance the employer. This system is in place as daily payments are not cost effective as each payment incurs a processing fee, as well as administration time and costs. While businesses use factoring services to finance receivables, employees need a similar service to obtain payment for their services prior to their employers' payroll schedule.

In accordance with the present invention, a new payment vehicle is provided which allows consumers and merchants to effectuate transactions that are not currently available to a large group of consumers. As will be described in greater detail below, this new payment vehicle benefits consumers by providing a choice for when to pay for previous merchant transactions.

In the following description, the terms “payor” and “payee” can also be used to refer to the parties of a financial transaction. The use of the terms “user” or “consumer” and “merchant” is not intended to limit the scope of the present invention.

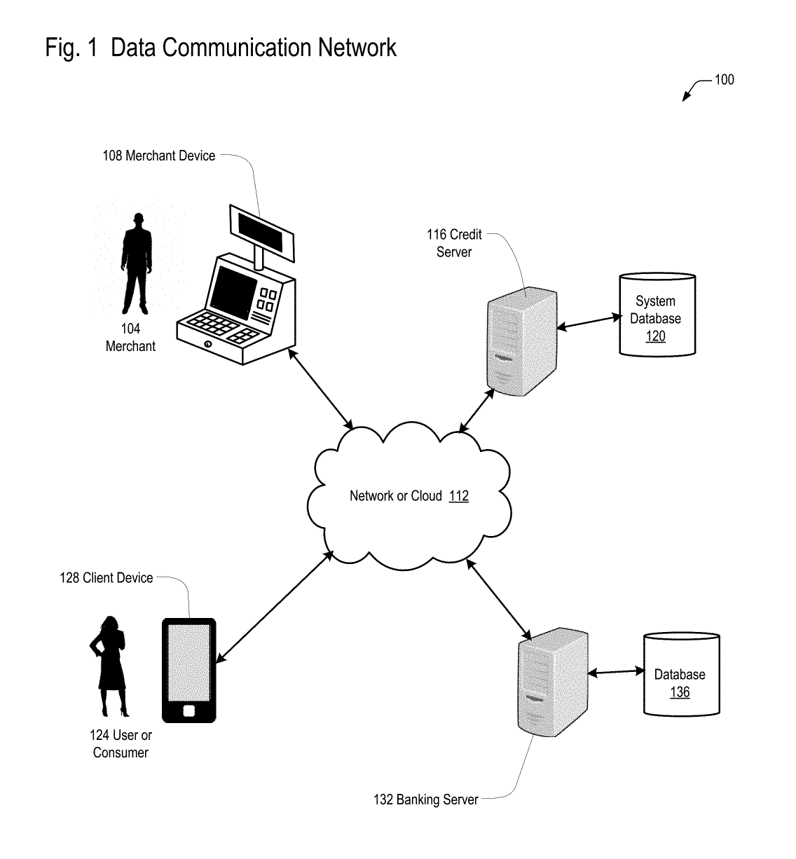

Referring now to FIG. 1, a diagram illustrating a Data Communication Network 100 in accordance with embodiments of the present invention is shown. Data communication network 100 provides intercommunication infrastructure between various entities involved with the processes of the present invention. Such networks may include, but are not limited to, wireless telecommunication networks, LANs (Local Area Networks), WANs (Wide Area Networks), WLANs (Wireless LANs), WWANs (Wireless WANs), telecommunication networks, baseband and broadband networks, and so forth. Data communication network 100 may also represent the Internet or one or more cloud networks, possibly including many servers, databases, and other devices.

Network 100 includes one or more merchant devices 108, used by one or more merchants 104 to conduct various purchase transactions. In the preferred embodiment, merchant device 108 is a point of sale (POS) terminal 108, which typically include a computer, a cash register, and other equipment or software used to sell goods or services. Merchant devices 108 also transmit sales data to be posted to customer accounts. Merchant device or point of sale terminal 108 may include one or more servers with associated databases, and other configurations useful for making purchase transactions.

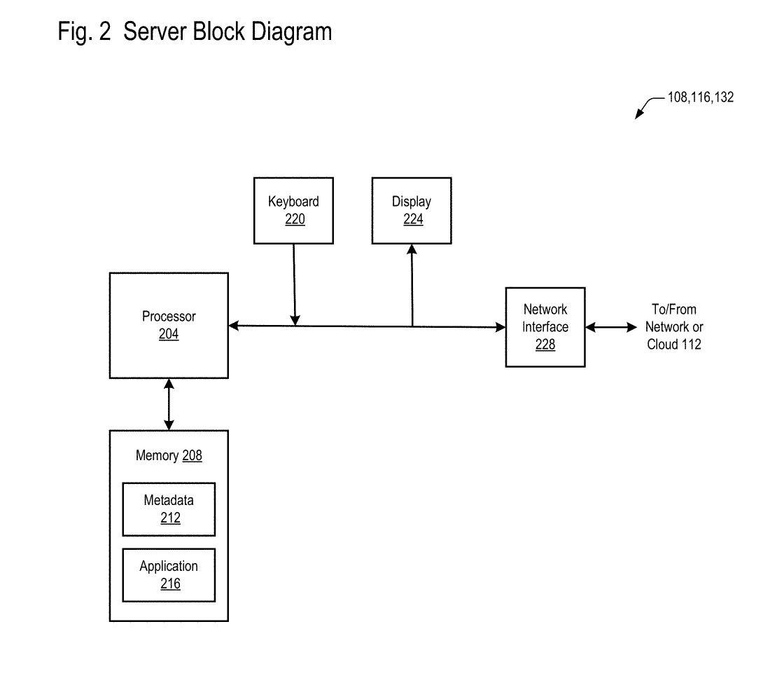

Network 100 also includes a credit server 116, which performs the primary processes of the present invention. Credit server 116 is described in more detail with respect to FIG. 2, and may include any number of servers. In some embodiments, credit server 116 is connected to one or more system databases 120, which stores consumer information including information about at least one financial account for a user or consumer 124. Various other items of information, including but not limited to a consumer address, driver's license information, and telephone number, may also be stored in system database 120. In one embodiment, system database 120 may be partitioned and may be located across multiple physical locations including within network or cloud 112. Furthermore, a system or network 100 may include more than one system database 120, and such databases would work cooperatively. For example, information pertaining to promotions of specific products may be retrieved from a system database 120 operated by a merchant 104 while instructions for payment processing may be stored on a remote system database 120 that is not operated by the merchant 104. System database 120 may contain information relating to the financial history of the consumer 124 or other information about the consumer 124 that may be used in scoring or otherwise determining when and in what amounts to approve transactions for consumer choice for payment. In some embodiments, system database 120 can also make use of data received from third party databases.

Network 100 may also include one or more banking servers 132. Banking servers 132 are operated by banks or other financial institutions connected to various financial networks for processing financial transactions. In the preferred embodiment, the functions performed by a banking server 132 are performed by a credit server 116 instead, or a credit/banking server 116. Banking server 132 or credit/banking server 116 access databases 136 to access various financial accounts related to consumer 124. Where the system or network 100 includes banking servers 132 separate from credit servers 116, credit server 116 transmits transaction processing instructions from system database 120 to banking server 132 or any other financial intermediary for processing payments.

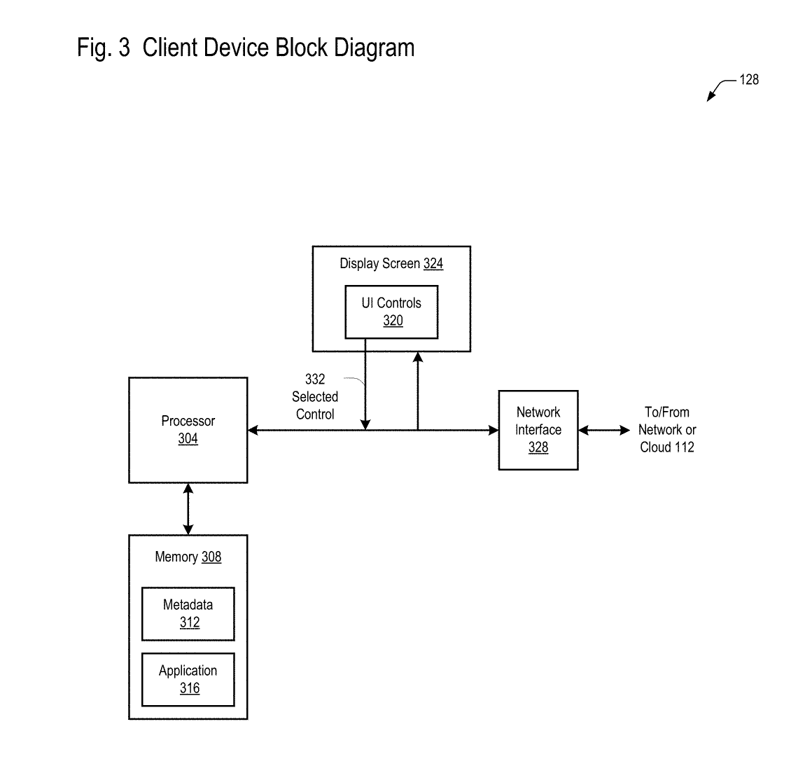

Network 100 also includes a client device 128 for consumer 124. Client device 128 is any type of computing device suitable for communicating with network or cloud 112 and the other elements of network 100, and is described in more detail with respect to FIG. 3. Client device 128 includes but is not limited to personal computers (PCs), handheld PCs, laptops, tablets, personal data assistants (PDA), mobile telephones, smartphones, smart accessories (e.g., a smartwatch, Google glasses, etc.), mobile internet devices, computer chip biological implants, and so forth. In accordance with embodiments of the present invention, after a transaction has occurred between the consumer 124 and a merchant 104, the consumer 124 and/or merchant 104 is notified of the transaction and chooses a payment time to process the payment. Payment processing is then subsequently initiated upon the arrival of a selected payment time. As would be appreciated, the specific determination of when to process the payment would be implementation dependent and can be performed in a variety of methods.

Referring now to FIG. 2, a block diagram illustrating a server in accordance with embodiments of the present invention is shown. Any of merchant device 108, credit server 116, or banking server 132 may be considered “servers” as described herein, although there are countless valid architectures and arrangements for suitable computing devices that may act as servers, most of which are not specifically represented herein.

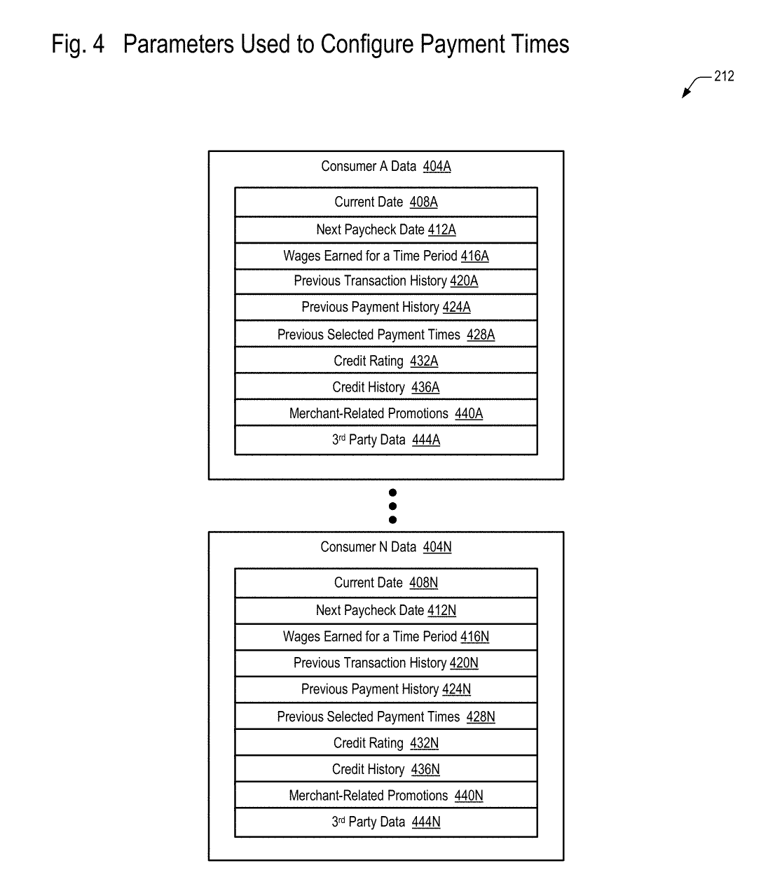

Server 108, 116, 132 includes one or more processors 204 and memory 208. The processor 204 may be any type of processors, including but not limited to X86 processors, RISC processors, Field Programmable Gate Arrays (FPGAs), Application Specific Integrated Circuits (ASICs), or any other form of central processing unit (CPU) that fetches and executes instructions and data from memory 208. The instructions may include the server 108, 116, 132 operating system, one or more applications 216 of the present invention, and third-party applications. The memory 208 may include various forms of metadata 212 as described in FIG. 4 and elsewhere including information obtained from any of databases 120, 136, as well as third party databases. Memory 208 includes both volatile and nonvolatile memories known in the art, and may include one or more portable memory devices including flash memory, USB sticks, SD cards, or the like.

Server 108, 116, 132 also includes one or more network interfaces 228 to interface to network or cloud 112. In some embodiments, the connection to network or cloud 112 is over standard Ethernet or other IP-based cabling. In other embodiments, the connection to network or cloud 112 is over radio frequency (RF) connections such as Wi-Fi, Bluetooth, or other radio access technologies including as 4G/5G and LTE.

Server 108, 116, 132 may include a visual display 224. The visual display 224 provides a user display for all video, text, and graphical annotation information used by a server 108, 116, 132 operator, possibly including merchant 104. The display 224 may also include a touch screen manipulated using a finger or stylus activated pointing device.

Finally, server 108, 116, 132 may also include a keyboard 220 of some type. In some embodiments, the keyboard 220 is a hardware alphanumeric keyboard provided as part of, or attached to server 108, 116, 132. In other embodiments, the keyboard 220 may be graphically displayed on the display 224, and key selection is performed either by finger or stylus contact.

Referring now to FIG. 3, a block diagram illustrating a client device 128 in accordance with embodiments of the present invention is shown. Client device 128 may be architecturally similar to server 108, 116, 132, although in many modern embodiments a consumer is more likely to use a portable computer of some sort (i.e. smartphone, pad device, wearable computer, etc).

Client device 128 includes one or more processors 304 and memory 308. The processor 304 may be any type of processor, including but not limited to X86 processors, RISC processors, Field Programmable Gate Arrays (FPGAs), Application Specific Integrated Circuits (ASICs), or any other form of central processing unit (CPU) that fetches and executes instructions and data from memory 308. The instructions may include the client device 128 operating system, one or more applications 316 of the present invention, and third-party applications. The memory 308 may include various forms of metadata 312. Memory 308 includes both volatile and nonvolatile memories known in the art, and may include one or more portable memory devices including flash memory, USB sticks, SD cards, or the like.

Client device 128 also includes one or more network interfaces 328 to interface to network or cloud 112. In some embodiments, the connection to network or cloud 112 is over standard Ethernet or other IP-based cabling. In other embodiments, the connection to network or cloud 112 is over radio frequency (RF) connections such as Wi-Fi, Bluetooth, or other radio access technologies including as 4G/5G and LTE.

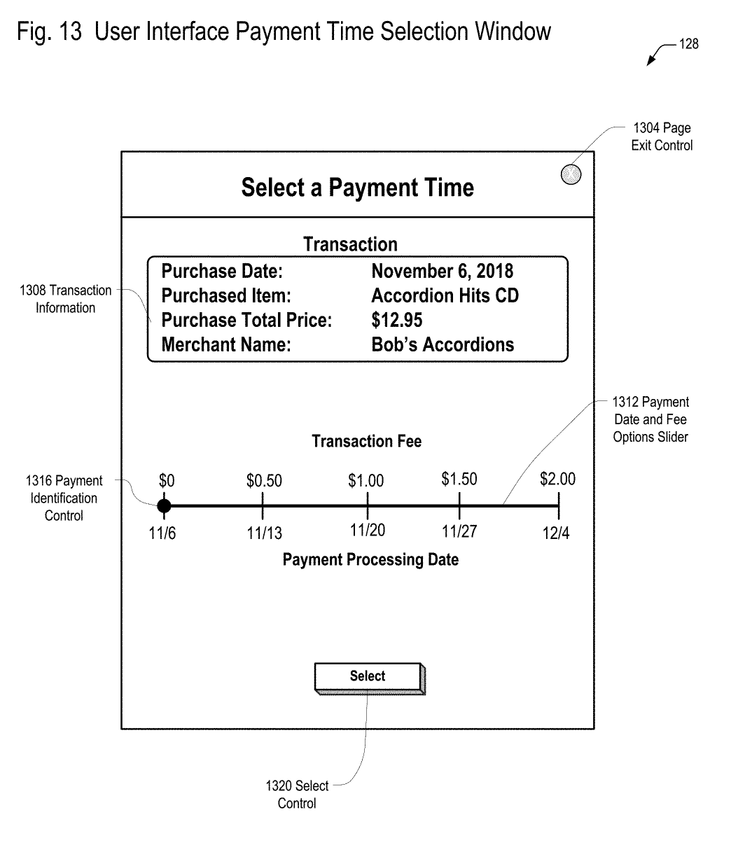

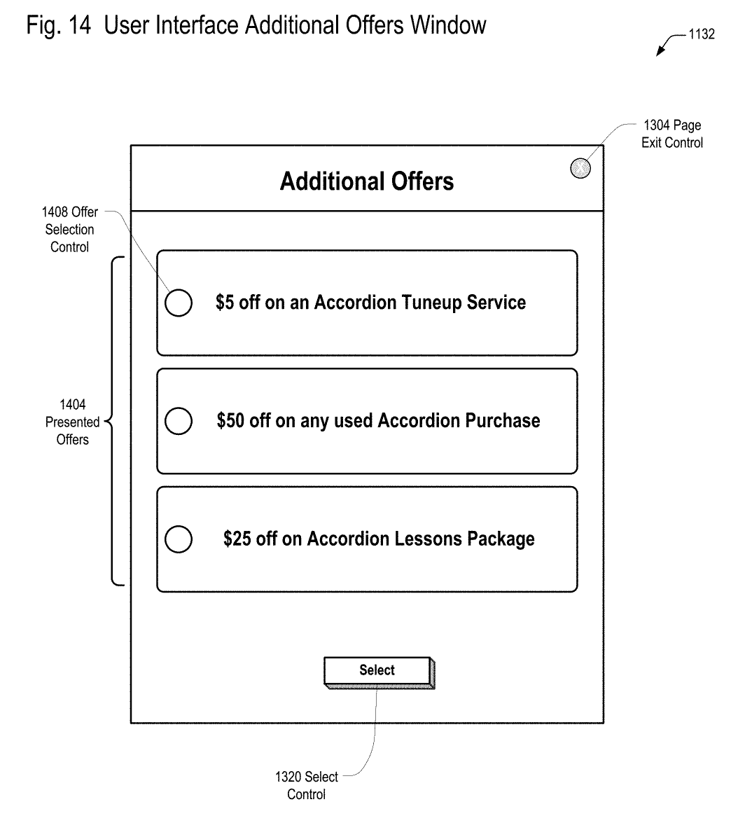

Client device 128 may include a display screen 324. The display screen 324 provides a user display for all video, text, and graphical annotation information used by a consumer or user 124. The display screen 324 may also include a touch screen allowing finger or stylus activated controls as part of user interface controls (UI controls) 320, which generate a selected control 332 as described herein and with specific reference to FIGS. 13 and 14.

Referring now to FIG. 4, a diagram illustrating Parameters 212 used to Configure Payment Times in accordance with embodiments of the present invention is shown. Parameters 212 in some embodiments are stored in metadata 212 of one or more of servers 108, 116, and 132, although it should be understood than any required parameters and data of the present invention may also be retrieved from databases 120, 136, or 3^{rd} party databases.

Parameters 212 include data for at least user or consumer 124, but may include data for any number N of users or consumers 124. The parameters 212 may include a current date 408, a current or next paycheck date 412, wages earned for a time period 416, a previous transaction history 420, a previous payment history 424, previous selected payment times 428, a credit rating 432, a credit history 436, merchant-related promotions 440, or 3^{rd} party data 444. 3^{rd} party data includes non-traditional risk scores other than a credit rating or credit history, that is provided by a 3^{rd} party. Parameters 212 are not limited to only the categories shown, and may include other parameters useful for performing the processes of the present invention.

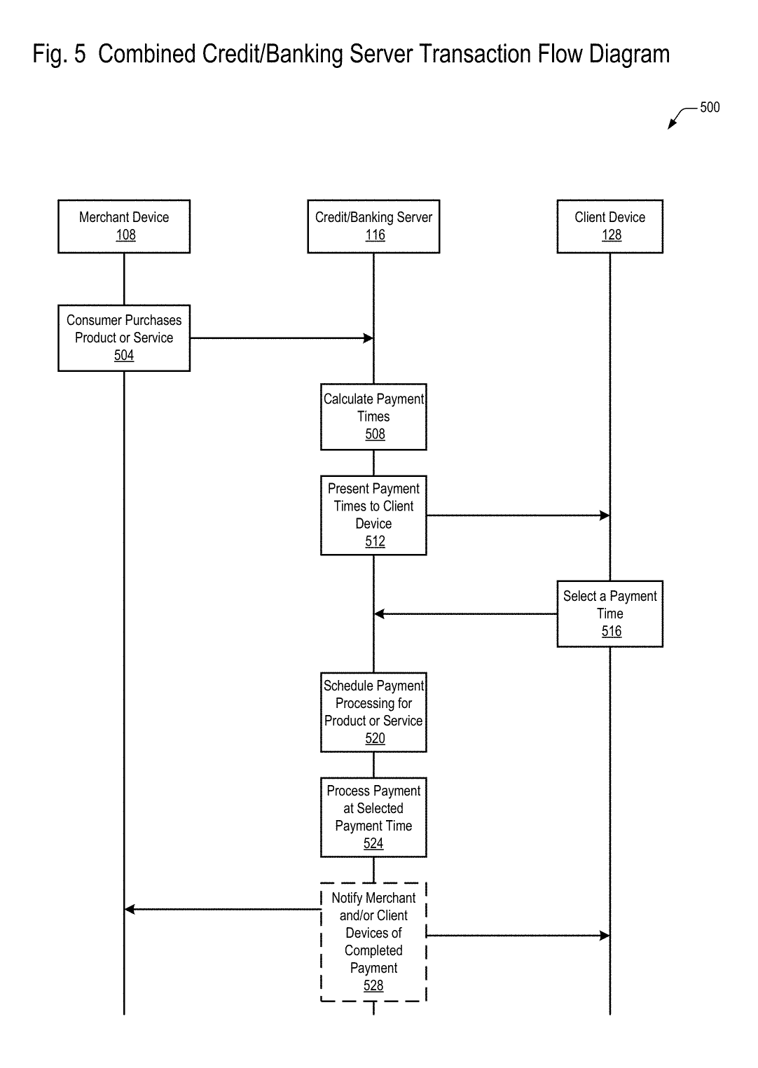

Referring now to FIG. 5, a flow diagram 500 illustrating a Transaction using a combined Credit/Banking Server in accordance with embodiments of the present invention. FIG. 5 illustrates a transaction flow of the preferred embodiment, where a credit/banking server 116 performs the primary processes of the present invention.

Merchant device 108 initiates the transaction when a consumer 124 purchases one or more products or services 504. In some embodiments, the consumer 124 makes the purchase at a point-of-sale system 108. In other embodiments, a consumer 124 initiates the purchase at a client device 128, perhaps through a website of a merchant 104 or other e-commerce site, and the purchase request is transferred to the merchant device 108 where the purchase 504 is initiated. In some embodiments, the consumer 124 uses a debit card to pay for the purchase transaction.

Credit/banking server 116 receives the purchase of one or more products or services 504, and calculates one or more payment times 508. In some embodiments, prior to calculating the payment times 508, the credit/banking server 116 determines whether the consumer 124 should be offered one or more payment times. In the event the credit/banking server 116 determines the consumer 124 should not be offered one or more payment times, the consumer 124 is instead required to pay for the product or service in accordance with the terms in effect at the time of the purchase.

After the credit/banking server 116 calculates the payment times 508, the credit/banking server 116 presents 512 the payment times to the client device 128 of the consumer 124. The client device 128 receives the payment times and displays them on a display 324 to the consumer 124. The consumer 124 then selects one of the presented payment times 516, which also causes the client device 128 to responsively transmit the selected payment time to the credit/banking server 116.

Based on the received selected payment time, the credit/banking server 116 schedules payment processing for the purchased product or service 520 and processes payment for the purchased product or service at the selected payment time 524. Processing the purchase transaction at the selected payment time includes the credit/banking server 116 debiting a consumer 124 account by the transaction amount of the purchase transaction and the selected transaction fee, if a transaction fee is applicable.

Finally and optionally, the credit/banking server 116 notifies one or both of the merchant 104 and the consumer 124 through the merchant device 108 or client device 128, respectively, that the payment for the purchased product or service has been completed 528.

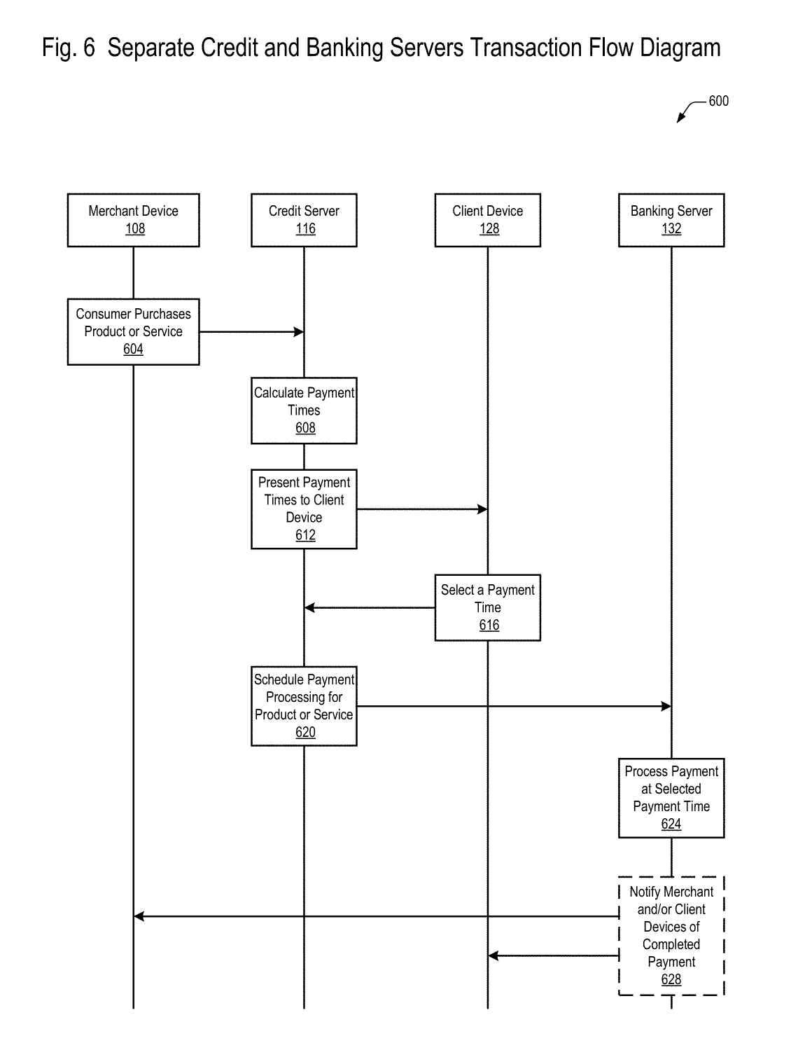

Referring now to FIG. 6, a flow diagram 600 illustrating a Transaction using Separate Credit and Banking Servers in accordance with embodiments of the present invention is shown. FIG. 6 illustrates a transaction flow of another embodiment, where a credit server 116 and separate banking server 136 jointly perform the primary processes of the present invention. This embodiment may be used where the credit entity 116 does not have banking capabilities and direct access to financial accounts.

Merchant device 108 initiates the transaction when a consumer 124 purchases one or more products or services 604. In some embodiments, the consumer 124 makes the purchase at a point-of-sale system 108. In other embodiments, a consumer 124 initiates the purchase at a client device 128, perhaps through a website of a merchant 104 or other e-commerce site, and the purchase request is transferred to the merchant device 108 where the purchase 604 is initiated. In some embodiments, the consumer 124 uses a debit card to pay for the purchase transaction.

Credit server 116 receives the purchase of one or more products or services 604, and calculates one or more payment times 608. In some embodiments, prior to calculating the payment times 608, the credit server 116 determines whether the consumer 124 should be offered one or more payment times. In the event the credit server 116 determines the consumer 124 should not be offered one or more payment times, the consumer 124 is instead required to for the product or service in accordance with the terms in effect at the time of the purchase.

After the credit server 116 calculates the payment times 608, the credit server 116 presents the payment times to the client device 128 of the consumer 612. The client device 128 receives the payment times and displays them on a display 324 to the consumer 124. The consumer 124 then selects one of the presented payment times 616, which also causes the client device 128 to responsively transmit the selected payment time to the credit server 116.

Based on the received selected payment time, the credit server 116 schedules payment processing for the purchased product or service 620 and notifies the banking server 136 to process payment for the purchased product or service at the selected payment time. The banking server 136 then processes payment for the purchased product or service at the selected payment time 624. Processing the purchase transaction at the selected payment time includes the banking server 132 debiting a consumer 124 account by the transaction amount of the purchase transaction and the selected transaction fee, if a transaction fee is applicable.

Finally and optionally, either the credit server 116 or the banking server 136 notifies one or both of the merchant 104 and the consumer 124 through the merchant device 108 or client device 128, respectively, that the payment for the purchased product or service has been completed 628.

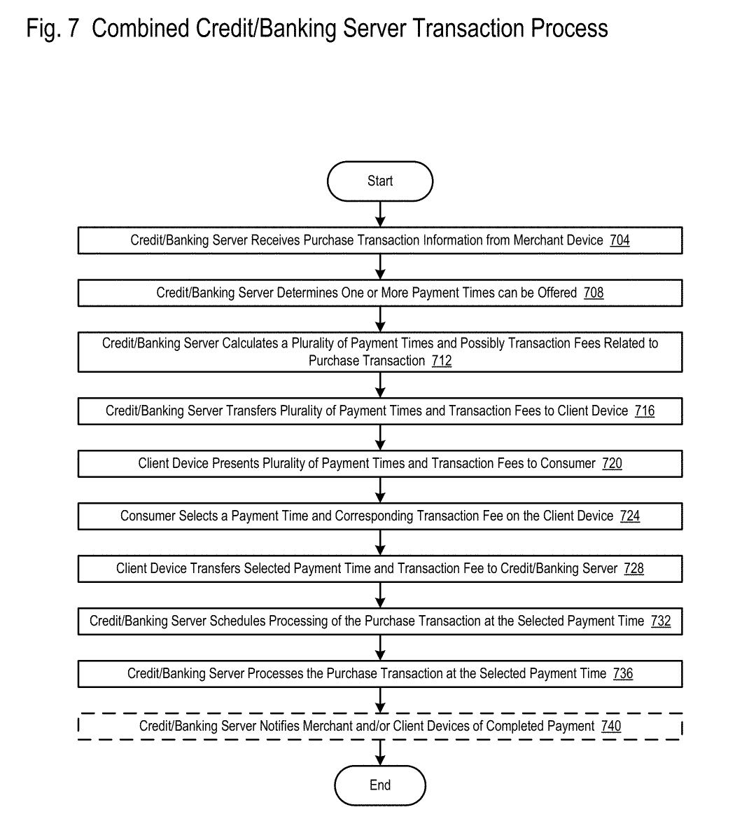

Referring now to FIG. 7, a flowchart illustrating a Combined Credit/Banking Server Transaction Process in accordance with embodiments of the present invention is shown. The embodiment illustrated in FIG. 7 utilizes a combined credit/banking server 116 to perform the various credit and banking-related steps of the illustrated process. Flow begins at block 704.

At block 704, the credit/banking server 116 receives purchase transaction information from a merchant device 108. The purchase transaction information includes at a minimum a transaction amount and a date, but in most embodiments also includes a merchant name and identification of a purchased item (good or service). In additional embodiments the purchase transaction information may include additional information including but not limited to merchant location, time of the transaction, type of merchant, tax, shipping information and the like. Flow proceeds to block 708.

At block 708, the credit/banking server 116 determines one or more payment times can be offered. Determining if one or more payment times can be offered is based on, but not limited to, one or more of a date 408, a pay date of the consumer 412 (e.g. a date at which a consumer account is paid by an employer), wages earned for a time period 416, the consumer's credit rating 432, information about a consumer's transaction history with the merchant 420, information about a consumer's transaction history with a plurality of merchants 420, information about a particular purchase or sale 420, or information about any merchant-supported promotions 440. In the event that no payment times can be offered (reflecting only an immediate payment time is available), the purchase is immediately completed and in some embodiments the consumer may be notified accordingly. “Immediately”, in the context of the present application, means the standard payment processing time for the payment device used by the consumer. In some embodiments, determining one or more payment times can be offered includes determining that a payment time can be offered for greater than none and less than all purchase transactions. Flow proceeds to block 712.

At block 712, the credit/banking server 116 calculates a plurality of payment times, and possibly transaction fees, related to the purchase transaction. The plurality of payment times includes at least an immediate payment time and a maximum payment time. Calculating one or more payment times is based on, including but not limited to, one or more of a date 408, a pay date of the consumer 412 (e.g. a date at which a consumer account is paid by an employer), wages earned for a time period 416, the consumer's credit rating 432, information about a consumer's transaction history with the merchant 420, information about a consumer's transaction history with a plurality of merchants 420, information about a particular purchase or sale 420, or information about any merchant-supported promotions 440. In some embodiments, some or all payment times may be associated with a transaction fee. In one embodiment, all payment times have the same associated transaction fee. In another embodiment, the immediate payment time has no associated transaction fee while other payment times have an associated transaction fee. In another embodiment, later payment times have higher transaction fees than earlier transaction times. In other embodiments, a plurality of earlier payment times have no transaction fees and later payment times than a predetermined payment time have an associated transaction fee. Flow proceeds to block 716.

At block 716, the credit/banking server 116 transfers the plurality of payment times calculated in block 712 and any corresponding transaction fees to a client device 128 of the user or consumer 124 who made the purchase transaction. In one embodiment, the credit/banking server 116 also transfers transaction information 1308 including a purchase date, a purchased item description, a purchase price, and a merchant name. In another embodiment, the transaction information 1308 may additionally include additional available credit. In other embodiments, less, more, or different information may be provided. Flow proceeds to block 720.

At block 720, the client device 128 presents the plurality of payment times and corresponding transaction fees to the consumer 124. Client device 128 includes an application 316 that displays the available payment times and corresponding transaction fees. An example of the display to the consumer 124 is shown in FIG. 13. Flow proceeds to block 724.

At block 724, the consumer 124 selects a payment time and corresponding transaction fee on the client device 128 from the options presented. In some embodiments, there may not be an applicable transaction fee corresponding to the selected payment time, or a transaction fee of $0. Flow proceeds to block 728.

At block 728, the client device 128 transfers the selected payment time 724 and corresponding transaction fee to the credit/banking server 116. In one embodiment, the client device 128 displays a “Select” or similar control 1320, which when activated initiates the information transfer to the credit/banking server 116. In other embodiments, other forms of selection and activation are used by the client device 128 and consumer 124 to send the desired information. Flow proceeds to block 732.

At block 732, the credit/banking server 116 schedules processing of the purchase transaction for the selected payment time 724. The scheduled processing will be either immediately or at a date in the future. In one embodiment, the scheduled processing is through an ACH (Automated Clearing House) network. Flow proceeds to block 736.

At block 736, the credit/banking server 116 processes the purchase transaction at the selected payment time 724. If no transaction fee corresponds to the selected payment time, then only the amount of the purchase transaction is processed. On the other hand, if a non-zero transaction fee corresponds to the selected payment time 724, then both the amount of the purchase transaction and the transaction fee are processed. Flow proceeds to optional block 740.

At optional block 740, the credit/banking server 116 notifies either or both of the merchant device 108 or the client device 128 of completed payment for the purchase transaction. Alternately, there is not an explicit notification of the completed payment, but a next bank statement to the consumer 124 will include the payment notification. Flow ends at optional block 740.

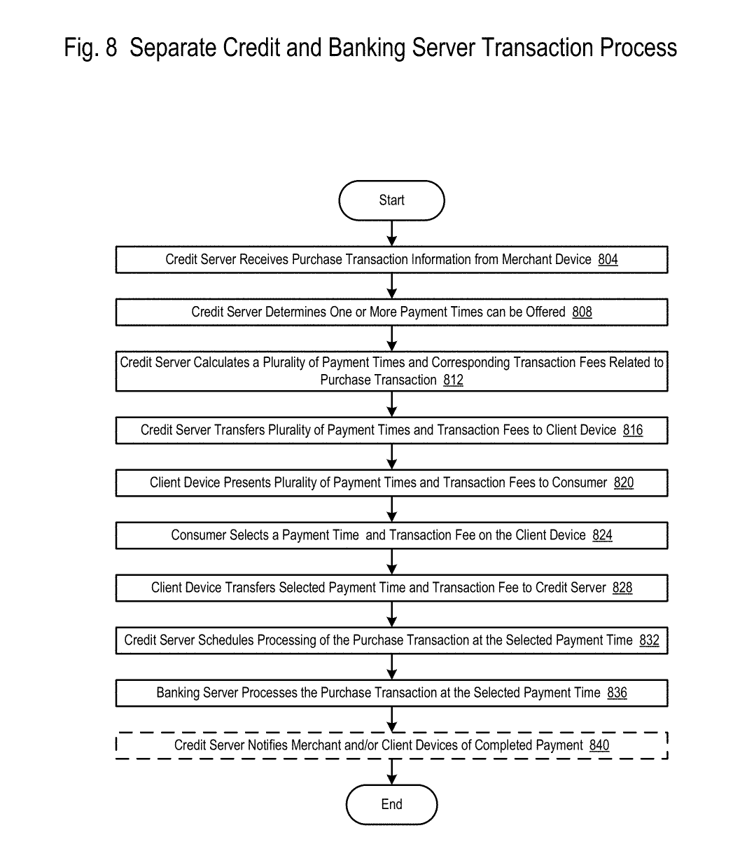

Referring now to FIG. 8, a flowchart illustrating a Separate Credit and Banking Server Transaction Process in accordance with embodiments of the present invention is shown. The embodiment illustrated in FIG. 8 utilizes separate credit 116 and banking 132 servers to perform the various credit and banking-related steps of the illustrated process. Flow begins at block 804.

At block 804, the credit server 116 receives purchase transaction information from a merchant device 108. The purchase transaction information includes at a minimum a transaction amount and a date, but in most embodiments also includes a merchant name and identification of a purchased item (good or service). Flow proceeds to block 808.

At block 808, the credit server 116 determines one or more payment times can be offered. Determining if one or more payment times can be offered is based on but not limited to one or more of a date 408, a pay date of the consumer 412 (e.g. a date at which a consumer account is paid by an employer), wages earned for a time period 416, the consumer's credit rating 432, information about a consumer's transaction history with the merchant 420, information about a consumer's transaction history with a plurality of merchants 420, information about a particular purchase or sale 420, or information about any merchant-supported promotions 440. In the event that no payment times can be offered (reflecting only an immediate payment time is available), the purchase is immediately completed and in some embodiments the consumer may be notified accordingly. “Immediately”, in the context of the present application, means the standard payment processing time for the payment device used by the consumer. In some embodiments, determining one or more payment times can be offered includes determining that a payment time can be offered for greater than none and less than all purchase transactions. Flow proceeds to block 812.

At block 812, the credit server 116 calculates a plurality of payment times, and possibly transaction fees, related to the purchase transaction. The plurality of payment times includes at least an immediate payment time and a maximum payment time. Calculating one or more payment times is based on but not limited to one or more of a date 408, a pay date of the consumer 412 (e.g. a date at which a consumer account is paid by an employer), wages earned for a time period 416, the consumer's credit rating 432, information about a consumer's transaction history with the merchant 420, information about a consumer's transaction history with a plurality of merchants 420, information about a particular purchase or sale 420, or information about any merchant-supported promotions 440. In some embodiments, some or all payment times may be associated with a transaction fee. In one embodiment, all payment times have the same associated transaction fee. In another embodiment, the immediate payment time has no associated transaction fee while other payment times have an associated transaction fee. In another embodiment, later payment times have higher transaction fees than earlier transaction times. In other embodiments, a plurality of earlier payment times have no transaction fees and later payment times than a predetermined payment time have an associated transaction fee. Flow proceeds to block 816.

At block 816, the credit server 116 transfers the plurality of payment times calculated in block 812 and any corresponding transaction fees to a client device 128 of the user or consumer 124 who made the purchase transaction. In one embodiment, the credit server 116 also transfers transaction information 1308 including a purchase date, a purchased item description, a purchase price, and a merchant name. In another embodiment, the transaction information 1308 may additionally include additional available credit. In other embodiments, less, more, or different information may be provided. Flow proceeds to block 820.

At block 820, the client device 128 presents the plurality of payment times and corresponding transaction fees to the consumer 124. Client device 128 includes an application 316 that displays the available payment times and corresponding transaction fees. An example of the display to the consumer 124 is shown in FIG. 13. Flow proceeds to block 824.

At block 824, the consumer 124 selects a payment time and corresponding transaction fee on the client device 128 from the options presented. In some embodiments, there may not be an applicable transaction fee corresponding to the selected payment time, or a transaction fee of $0. Flow proceeds to block 828.

At block 828, the client device 128 transfers the selected payment time 824 and corresponding transaction fee to the credit server 116. In one embodiment, the client device 128 displays a “Select” or similar control 1320, which when activated initiates the information transfer to the credit server 116. In other embodiments, other forms of selection and activation are used by the client device 128 and consumer 124 to send the desired information. Flow proceeds to block 832.

At block 832, the credit server 116 schedules processing of the purchase transaction for the selected payment time 824. The scheduled processing will be either immediately or at a date in the future. In one embodiment, the scheduled processing is through an ACH (Automated Clearing House) network. Flow proceeds to block 836.

At block 836, the banking server 132 processes the purchase transaction at the selected payment time 824. If no transaction fee corresponds to the selected payment time 824, then only the amount of the purchase transaction is processed. On the other hand, if a non-zero transaction fee corresponds to the selected payment time 824, then both the amount of the purchase transaction and the transaction fee are processed. Flow proceeds to optional block 840.

At optional block 840, the credit server 116 notifies either or both of the merchant device 108 or the client device 128 of completed payment for the purchase transaction. Alternately, there is not an explicit notification of the completed payment, but a next bank statement to the consumer 124 will include the payment notification. Flow ends at optional block 840.

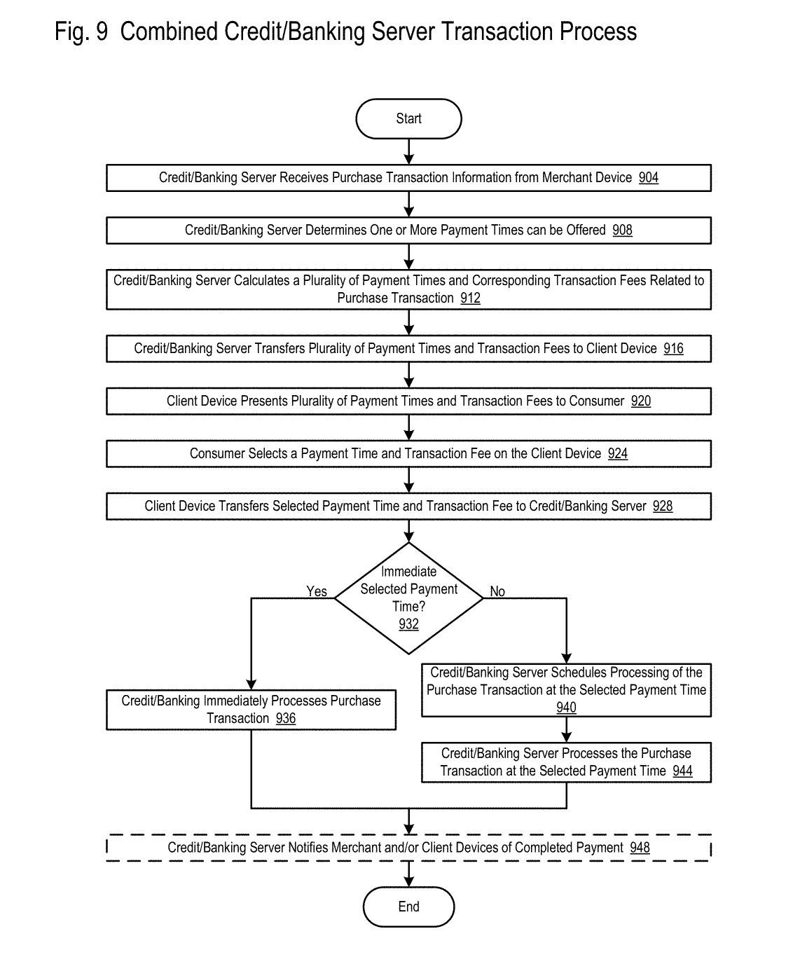

Referring now to FIG. 9, a flowchart illustrating a Combined Credit/Banking Server Transaction Process in accordance with embodiments of the present invention is shown. The embodiment illustrated in FIG. 9 utilizes a combined credit/banking server 116 to perform the various credit and banking-related steps of the illustrated process, and provides alternatives for immediate and scheduled-in the-future payment processing. Flow begins at block 904.

At block 904, the credit/banking server 116 receives purchase transaction information from a merchant device 108. The purchase transaction information includes at a minimum a transaction amount and a date, but in most embodiments also includes a merchant name and identification of a purchased item (good or service). Flow proceeds to block 908.

At block 908, the credit/banking server 116 determines one or more payment times can be offered. Determining if one or more payment times can be offered is based on but not limited to one or more of a date 408, a pay date of the consumer 412 (e.g. a date at which a consumer account is paid by an employer), wages earned for a time period 416, the consumer's credit rating 432, information about a consumer's transaction history with the merchant 420, information about a consumer's transaction history with a plurality of merchants 420, information about a particular purchase or sale 420, or information about any merchant-supported promotions 440. In the event that no payment times can be offered (reflecting only an immediate payment time is available), the purchase is immediately completed and in some embodiments the consumer may be notified accordingly. “Immediately”, in the context of the present application, means the standard payment processing time for the payment device used by the consumer. In some embodiments, determining one or more payment times can be offered includes determining that a payment time can be offered for greater than none and less than all purchase transactions. Flow proceeds to block 912.

At block 912, the credit/banking server 116 calculates a plurality of payment times, and possibly transaction fees, related to the purchase transaction. The plurality of payment times includes at least an immediate payment time and a maximum payment time. Calculating one or more payment times is based on but not limited to one or more of a date 408, a pay date of the consumer 412 (e.g. a date at which a consumer account is paid by an employer), wages earned for a time period 416, the consumer's credit rating 432, information about a consumer's transaction history with the merchant 420, information about a consumer's transaction history with a plurality of merchants 420, information about a particular purchase or sale 420, or information about any merchant-supported promotions 440. In some embodiments, some or all payment times may be associated with a transaction fee. In one embodiment, all payment times have the same associated transaction fee. In another embodiment, the immediate payment time has no associated transaction fee while other payment times have an associated transaction fee. In another embodiment, later payment times have higher transaction fees than earlier transaction times. In other embodiments, a plurality of earlier payment times have no transaction fees and later payment times than a predetermined payment time have an associated transaction fee. Flow proceeds to block 916.

At block 916, the credit/banking server 116 transfers the plurality of payment times calculated in block 912 and any corresponding transaction fees to a client device 128 of the user or consumer 124 who made the purchase transaction. In one embodiment, the credit/banking server 116 also transfers transaction information 1308 including a purchase date, a purchased item description, a purchase price, and a merchant name. In another embodiment, the transaction information 1308 may additionally include additional available credit. In other embodiments, less, more, or different information may be provided. Flow proceeds to block 920.

At block 920, the client device 128 presents the plurality of payment times and corresponding transaction fees to the consumer 124. Client device 128 includes an application 316 that displays the available payment times and corresponding transaction fees. An example of the display to the consumer 124 is shown in FIG. 13. Flow proceeds to block 924.

At block 924, the consumer 124 selects a payment time and corresponding transaction fee on the client device 128 from the options presented. In some embodiments, there may not be an applicable transaction fee corresponding to the selected payment time, or a transaction fee of $0. Flow proceeds to block 928.

At block 928, the client device 128 transfers the selected payment time 924 and corresponding transaction fee to the credit/banking server 116. In one embodiment, the client device 128 displays a “Select” or similar control 1320, which when activated initiates the information transfer to the credit/banking server 116. In other embodiments, other forms of selection and activation are used by the client device 128 and consumer 124 to send the desired information. Flow proceeds to decision block 932.

At decision block 932, the credit/banking server 116 determines if an immediate payment time has been selected by the consumer 124. If an immediate payment time has been selected by the consumer 124, then flow proceeds to block 936. If instead an immediate payment time has not been selected by the consumer 124, then flow proceeds to block 940.

At block 936, the credit/banking server 116 immediately processes the purchase transaction, and consumer funds are used to pay for the transaction. In some embodiments, there is no transaction fee for immediate payment. In other embodiments, there is a non-zero transaction fee for an immediate payment. Flow proceeds to optional block 948.

At block 940, the credit/banking server 116 schedules processing of the purchase transaction for the selected payment time 924. In one embodiment, the scheduled processing is through an ACH (Automated Clearing House) network. Flow proceeds to block 944.

At block 944, the credit/banking server 116 processes the purchase transaction at the selected payment time 924. If no transaction fee corresponds to the selected payment time 924, then only the amount of the purchase transaction is processed. On the other hand, if a non-zero transaction fee corresponds to the selected payment time 924, then both the amount of the purchase transaction and the transaction fee are processed. Flow proceeds to optional block 948.

At optional block 948, the credit/banking server 116 notifies either or both of the merchant device 108 or the client device 128 of completed payment for the purchase transaction. Alternately, there is not an explicit notification of the completed payment, but a next bank statement to the consumer 124 will include the payment notification. Flow ends at optional block 948.

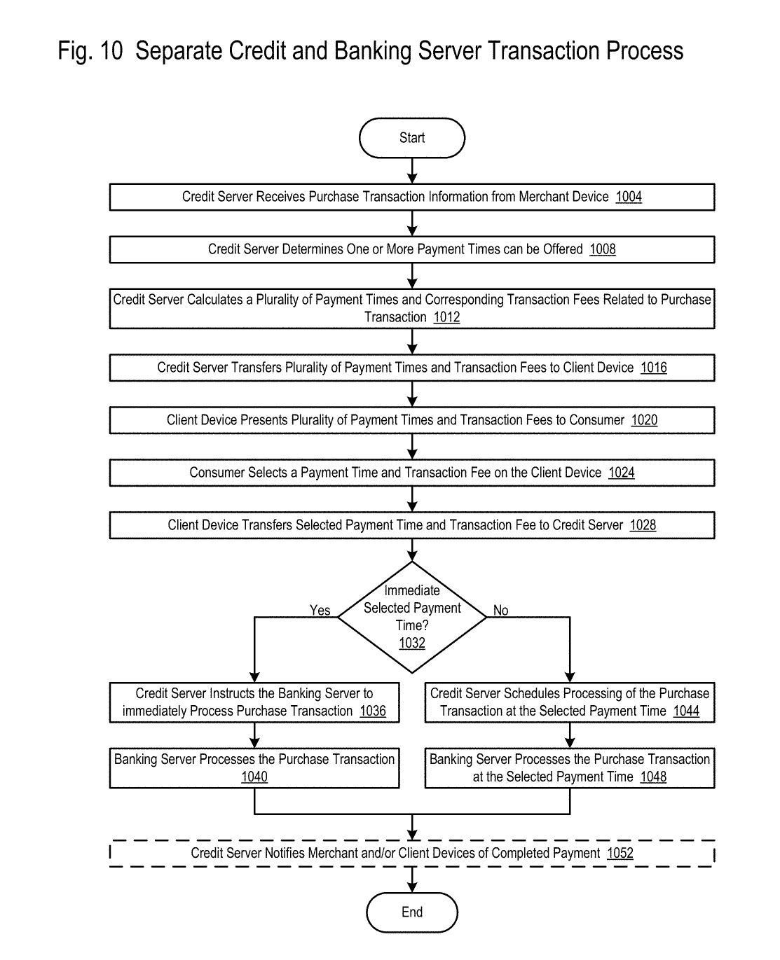

Referring now to FIG. 10, a flowchart illustrating a Separate Credit and Banking Server Transaction Process in accordance with embodiments of the present invention is shown. The embodiment illustrated in FIG. 10 utilizes separate credit 116 and banking 132 servers to perform the various credit and banking-related steps of the illustrated process, and provides alternatives for immediate and scheduled-in the-future payment processing. Flow begins at block 1004.

At block 1004, the credit server 116 receives purchase transaction information from a merchant device 108. The purchase transaction information includes at a minimum a transaction amount and a date, but in most embodiments also includes a merchant name and identification of a purchased item (good or service). Flow proceeds to block 1008.

At block 1008, the credit server 116 determines one or more payment times can be offered. Determining if one or more payment times can be offered is based on but not limited to one or more of a date 408, a pay date of the consumer 412 (e.g. a date at which a consumer account is paid by an employer), wages earned for a time period 416, the consumer's credit rating 432, information about a consumer's transaction history with the merchant 420, information about a consumer's transaction history with a plurality of merchants 420, information about a particular purchase or sale 420, or information about any merchant-supported promotions 440. In the event that no payment times can be offered (reflecting only an immediate payment time is available), the purchase is immediately completed and in some embodiments the consumer may be notified accordingly. “Immediately”, in the context of the present application, means the standard payment processing time for the payment device used by the consumer. In some embodiments, determining one or more payment times can be offered includes determining that a payment time can be offered for greater than none and less than all purchase transactions. Flow proceeds to block 1012.

At block 1012, the credit server 116 calculates a plurality of payment times, and possibly transaction fees, related to the purchase transaction. The plurality of payment times includes at least an immediate payment time and a maximum payment time. Calculating one or more payment times is based on but not limited to one or more of a date 408, a pay date of the consumer 412 (e.g. a date at which a consumer account is paid by an employer), wages earned for a time period 416, the consumer's credit rating 432, information about a consumer's transaction history with the merchant 420, information about a consumer's transaction history with a plurality of merchants 420, information about a particular purchase or sale 420, or information about any merchant-supported promotions 440. In some embodiments, some or all payment times may be associated with a transaction fee. In one embodiment, all payment times have the same associated transaction fee. In another embodiment, the immediate payment time has no associated transaction fee while other payment times have an associated transaction fee. In another embodiment, later payment times have higher transaction fees than earlier transaction times. In other embodiments, a plurality of earlier payment times have no transaction fees and later payment times than a predetermined payment time have an associated transaction fee. Flow proceeds to block 1016.

At block 1016, the credit server 116 transfers the plurality of payment times calculated in block 1012 and any corresponding transaction fees to a client device 128 of the user or consumer 124 who made the purchase transaction. In one embodiment, the credit server 116 also transfers transaction information 1308 including a purchase date, a purchased item description, a purchase price, and a merchant name. In another embodiment, the transaction information 1308 may additionally include additional available credit. In other embodiments, less, more, or different information may be provided. Flow proceeds to block 1020.

At block 1020, the client device 128 presents the plurality of payment times and corresponding transaction fees to the consumer 124. Client device 128 includes an application 316 that displays the available payment times and corresponding transaction fees. An example of the display to the consumer 124 is shown in FIG. 13. Flow proceeds to block 1024.

At block 1024, the consumer 124 selects a payment time and corresponding transaction fee on the client device 128 from the options presented. In some embodiments, there may not be an applicable transaction fee corresponding to the selected payment time, or a transaction fee of $0. Flow proceeds to block 1028.

At block 1028, the client device 128 transfers the selected payment time 1024 and corresponding transaction fee to the credit server 116. In one embodiment, the client device 128 displays a “Select” or similar control 1320, which when activated initiates the information transfer to the credit/banking server 116. In other embodiments, other forms of selection and activation are used by the client device 128 and consumer 124 to send the desired information. Flow proceeds to decision block 1032.

At decision block 1032, the credit server 116 determines if an immediate payment time has been selected by the consumer 124. If an immediate payment time has been selected by the consumer 124, then flow proceeds to block 1036. If instead an immediate payment time has not been selected by the consumer 124, then flow proceeds to block 1044.

At block 1036, the credit server 116 instructs the banking server 132 to immediately process the purchase transaction. Flow proceeds to block 1040.

At block 1040, the banking server 132 immediately processes the purchase transaction, and consumer funds are used to pay for the transaction. In some embodiments, there is no transaction fee for immediate payment. In other embodiments, there is a non-zero transaction fee for an immediate payment. Flow proceeds to optional block 1052.

At block 1044, the credit server 116 schedules processing of the purchase transaction for the selected payment time 1024. In one embodiment, the scheduled processing is through an ACH (Automated Clearing House) network. Flow proceeds to block 1048.

At block 1048, the banking server 132 processes the purchase transaction at the scheduled payment time 1024, and consumer funds are used to pay for the transaction. In some embodiments, there is no transaction fee for immediate payment. In other embodiments, there is a non-zero transaction fee for an immediate payment. Flow proceeds to optional block 1052.

At optional block 1052, the credit server 116 notifies either or both of the merchant device 108 or the client device 128 of completed payment for the purchase transaction. Alternately, there is not an explicit notification of the completed payment, but a next bank statement to the consumer 124 will include the payment notification. Flow ends at optional block 1052.

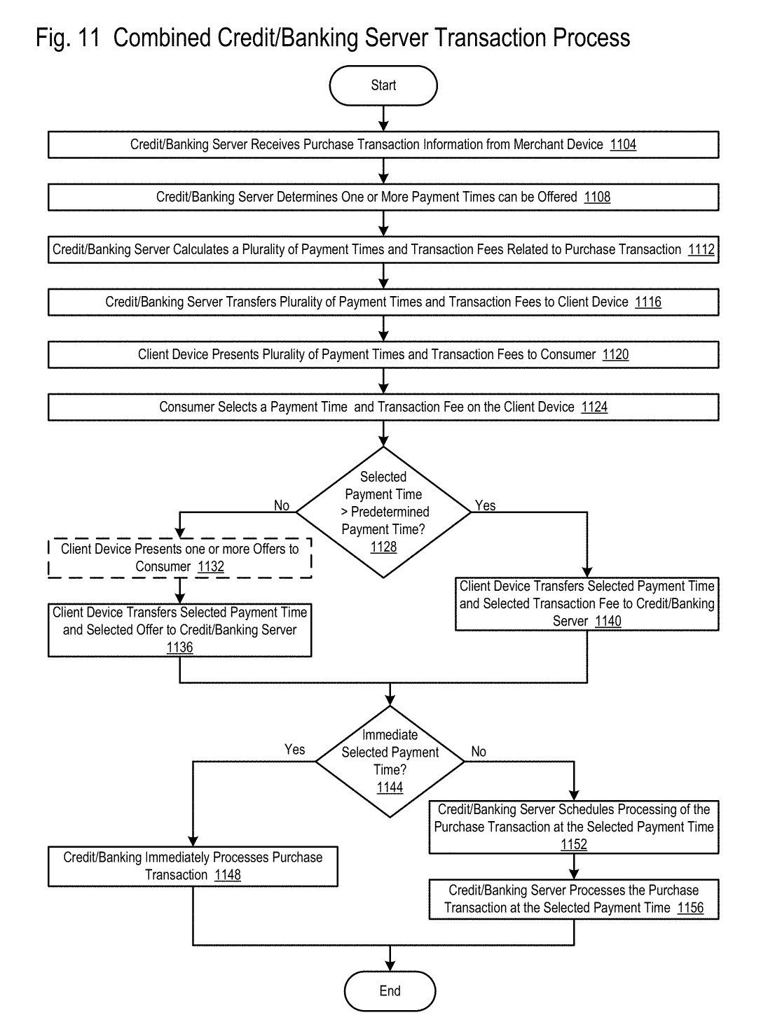

Referring now to FIG. 11, a flowchart illustrating a Combined Credit/Banking Server Transaction Process in accordance with embodiments of the present invention is shown. The embodiment illustrated in FIG. 11 utilizes a combined credit/banking server 116 to perform the various credit and banking-related steps of the illustrated process, and provides alternatives for both a predetermined payment time and immediate and scheduled-in the-future payment processing. Flow begins at block 1104.

At block 1104, the credit/banking server 116 receives purchase transaction information from a merchant device 108. The purchase transaction information includes at a minimum a transaction amount and a date, but in most embodiments also includes a merchant name and identification of a purchased item (good or service). Flow proceeds to block 1108.

At block 1108, the credit/banking server 116 determines one or more payment times can be offered. Determining if one or more payment times can be offered is based on but not limited to one or more of a date 408, a pay date of the consumer 412 (e.g. a date at which a consumer account is paid by an employer), wages earned for a time period 416, the consumer's credit rating 432, information about a consumer's transaction history with the merchant 420, information about a consumer's transaction history with a plurality of merchants 420, information about a particular purchase or sale 420, or information about any merchant-supported promotions 440. In the event that no payment times can be offered (reflecting only an immediate payment time is available), the purchase is immediately completed and in some embodiments the consumer may be notified accordingly. In some embodiments, determining one or more payment times can be offered includes determining that a payment time can be offered for greater than none and less than all purchase transactions. Flow proceeds to block 1112.

At block 1112, the credit/banking server 116 calculates a plurality of payment times, and possibly transaction fees, related to the purchase transaction. The plurality of payment times includes at least an immediate payment time and a maximum payment time. “Immediately”, in the context of the present application, means the standard payment processing time for the payment device used by the consumer. Calculating one or more payment times is based on but not limited to one or more of a date 408, a pay date of the consumer 412 (e.g. a date at which a consumer account is paid by an employer), wages earned for a time period 416, the consumer's credit rating 432, information about a consumer's transaction history with the merchant 420, information about a consumer's transaction history with a plurality of merchants 420, information about a particular purchase or sale 420, or information about any merchant-supported promotions 440. In some embodiments, some or all payment times may be associated with a transaction fee. In one embodiment, all payment times have the same associated transaction fee. In another embodiment, the immediate payment time has no associated transaction fee while other payment times have an associated transaction fee. In another embodiment, later payment times have higher transaction fees than earlier transaction times. In other embodiments, a plurality of earlier payment times have no transaction fees and later payment times than a predetermined payment time have an associated transaction fee. Flow proceeds to block 1116.

At block 1116, the credit/banking server 116 transfers the plurality of payment times calculated in block 1112 and any corresponding transaction fees to a client device 128 of the user or consumer 124 who made the purchase transaction. In one embodiment, the credit/banking server 116 also transfers transaction information 1308 including a purchase date, a purchased item description, a purchase price, and a merchant name. In another embodiment, the transaction information 1308 may additionally include additional available credit. In other embodiments, less, more, or different information may be provided. Flow proceeds to block 1120.

At block 1120, the client device 128 presents the plurality of payment times and corresponding transaction fees to the consumer 124. Client device 128 includes an application 316 that displays the available payment times and corresponding transaction fees. An example of the display to the consumer 124 is shown in FIG. 13. Flow proceeds to block 1124.

At block 1124, the consumer 124 selects a payment time and corresponding transaction fee on the client device 128 from the options presented. In some embodiments, there may not be an applicable transaction fee corresponding to the selected payment time, or a transaction fee of $0. Flow proceeds to decision block 1128.

At decision block 1128, the application 316 of the client device 128 determines if the selected payment time 1124 is greater than a predetermined payment time. The predetermined payment time is an incentivized payment time whereby payment at or before the predetermined payment time does not have an associated transaction fee and in some embodiments may have one or more corresponding offers or discounts offered to the consumer 124. If the selected payment time 1124 is greater than the predetermined payment time, then flow proceeds to block 1140. If instead the selected payment time 1124 is not greater than the predetermined payment time, then flow proceeds to optional block 1132.

At optional block 1132, the application 316 of the client device 128 presents one or more offers to the consumer 124. An example of the one or more offers are shown in FIG. 14, and may be presented in any conceivable fashion, whether a single offer, a group of offers, or a choice of one or more offers. The offers may be any form of reward, including but not limited to discounts, coupons, merchandise, a credit, a reimbursement, or any other form of incentive. In some embodiments, no offers are presented to the consumer 124. Flow proceeds to block 1136.

At block 1136, the client device 128 transfers the selected payment time 1124 to the credit/banking server 116. In one embodiment, the client device 128 displays a “Select” or similar control 1320, which when activated initiates the information transfer to the credit/banking server 116. In other embodiments, other forms of selection and activation are used by the client device 128 and consumer 124 to send the desired information. Flow proceeds to decision block 1144.

At block 1140, the client device 128 transfers the selected payment time 1124 and corresponding transaction fee to the credit/banking server 116. In one embodiment, the client device 128 displays a “Select” or similar control 1320, which when activated initiates the information transfer to the credit/banking server 116. In other embodiments, other forms of selection and activation are used by the client device 128 and consumer 124 to send the desired information. Flow proceeds to decision block 1144.

At decision block 1144, the credit/banking server 116 determines if an immediate payment time has been selected by the consumer 124. If an immediate payment time has been selected by the consumer 124, then flow proceeds to block 1148. If instead an immediate payment time has not been selected by the consumer 124, then flow proceeds to block 1152.

At block 1148, the credit/banking server 116 immediately processes the purchase transaction, and consumer funds are used to pay for the transaction. In some embodiments, the credit/banking server 116 also notifies one or both of the client device 128 and merchant device 108 of the completed payment. Flow ends at block 1148.

At block 1152, the credit/banking server 116 schedules processing of the purchase transaction for the selected payment time 1124. In one embodiment, the scheduled processing is through an ACH (Automated Clearing House) network. Flow proceeds to block 1156.

At block 1156, the credit/banking server 116 processes the purchase transaction at the selected payment time 1124. If no transaction fee corresponds to the selected payment time, then only the amount of the purchase transaction is processed. On the other hand, if a non-zero transaction fee corresponds to the selected payment time, then both the amount of the purchase transaction and the transaction fee are processed. In some optional embodiments, the credit/banking server 116 also notifies one or both of the client device 128 and merchant device 108 of the completed payment. Flow ends at block 1156.

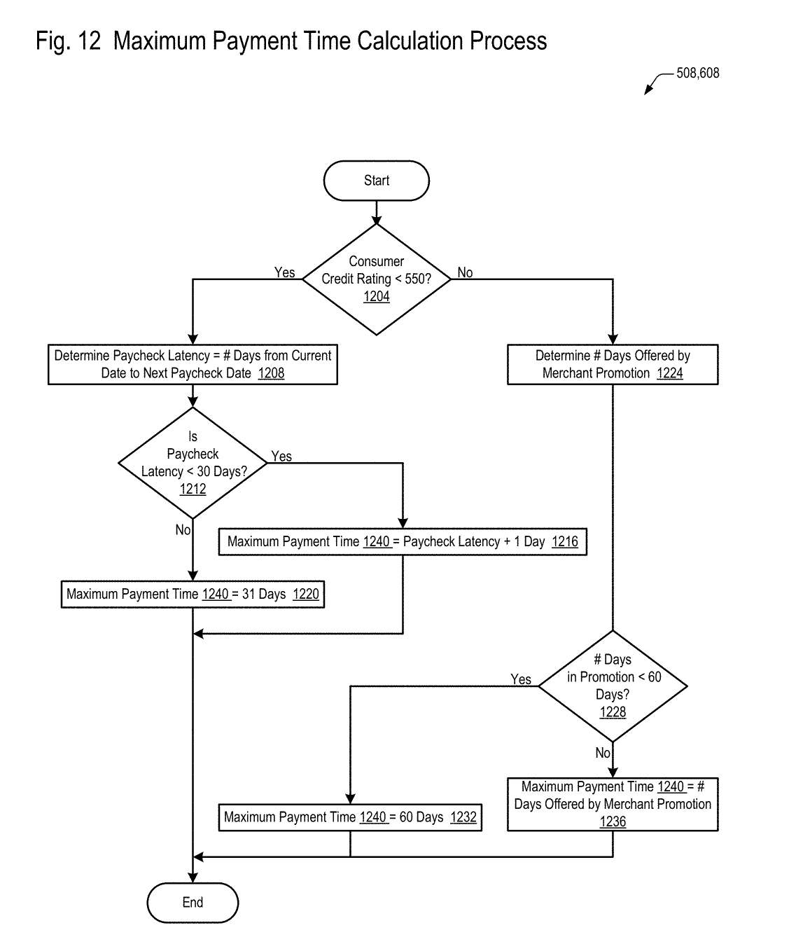

Referring now to FIG. 12, a flowchart illustrating a Maximum Payment Time Calculation Process 508, 608 in accordance with embodiments of the present invention is shown. Once the credit server 116 or credit/banking server 116 has determined that one or more payment times can be offered, the actual payment times are established and may be based on many factors as described previously. FIG. 12 illustrates an example of calculating a maximum payment time based on a consumer credit rating 432, a current date 408, a next paycheck date 412, and a merchant promotion 440. Once a maximum payment time has been established, intermediate payment times (i.e. between an immediate payment time and the maximum payment time) may optionally be calculated based on similar or different criteria to give more payment time choices to a consumer 124. Flow begins at decision block 1204.

At decision block 1204, the credit server 116 or credit/banking server 116 determines if the consumer credit rating 432 is less than 550. In other embodiments, a different credit rating 432 figure may be used for comparison. If the consumer credit rating 432 is below 550, then flow proceeds to block 1208. If instead the consumer credit rating 432 is not below 550, then flow proceeds to block 1224.

At block 1208, the credit server 116 or credit/banking server 116 determines paycheck latency is a number of days from a current date 408 to a next paycheck date 412. Flow proceeds to decision block 1212.

At decision block 1212, the credit server 116 or credit/banking server 116 determines if the paycheck latency calculated in block 1208 is less than 30 days. In other embodiments, a different number of days comparison for paycheck latency may be used. If the paycheck latency is less than 30 days, then flow proceeds to block 1216. If instead the paycheck latency is not less than 30 days, then flow proceeds to block 1220.

At block 1216, the credit server 116 or credit/banking server 116 calculates the maximum payment time 1240 equal to the paycheck latency calculated in block 1208, plus one day. This allows for one day following a payday to ensure a deposit is credited. Flow ends at block 1216.

At block 1220, the credit server 116 or credit/banking server 116 calculates the maximum payment time 1240 equal to 31 days, which provides for a month of any length. Flow ends at block 1220.

At block 1224, the credit server 116 or credit/banking server 116 determines a number of days offered by a merchant promotion 440. Merchant promotions 440 may practically be of any length. Flow proceeds to decision block 1228.

At decision block 1228, the credit server 116 or credit/banking server 116 determines if the number of days offered by the merchant promotion 440 in block 1224 is less than 60 days. 60 days could be used if the credit decision might be to not allow delayed payments of more than two months. In other embodiments, a different number of days comparison for merchant promotion may be used. If the number of days offered by the merchant promotion is less than 60 days, then flow proceeds to block 1232. If instead the number of days offered by the merchant promotion is not less than 60 days, then flow proceeds to block 1236.

At block 1232, the credit server 116 or credit/banking server 116 sets the maximum payment time 1240 equal to 60 days. Flow ends at block 1232.

At block 1236, the credit server 116 or credit/banking server 116 sets the maximum payment time 1240 equal to the number of days offered by the merchant promotion 1236. Flow ends at block 1236.

FIG. 12 represents one of many such possible examples, and such information can be presented in countless other ways without deviating from the scope and intent of the present application. Each of the fields and information shown may or may not be presented in other examples or presented in a similar fashion to that illustrated herein. The following description therefore applies to the illustrated example, and may or may not apply to other possible examples.

Referring now to FIG. 13, a diagram illustrating a User Interface Payment Time Selection Window in accordance with embodiments of the present invention is shown. The user interface window is displayed on the client device 128 when the client device 128 receives a payment times notification from the credit server 116 or credit/banking server 116 and presents the payment times to the consumer 124 (see blocks 512, 612, 720, 820, 920, 1020, and 1120). In a preferred embodiment, the client device 128 receives the payment times notification the same day of a purchase transaction. In other embodiments, the payment times notification may be received by the client device 128 the next day or another day.

FIG. 13 represents one of many such possible examples, and such information can be presented in countless other ways without deviating from the scope and intent of the present application. Each of the fields and information shown may or may not be presented in other examples or presented in a similar fashion to that illustrated herein. The following description therefore applies to the illustrated example, and may or may not apply to other possible examples.

The user interface window includes a page exit control 1304, which terminates the displayed page and returns the display to a previous state (i.e. whatever was being displayed prior to the “Select a Payment Time” window). The user interface page also includes some form of transaction information 1308, from which the consumer 124 may uniquely identify the transaction from any other purchase transactions the user or consumer 124 may have made. In one embodiment, the transaction information 1308 includes a purchase date, a purchased item description, a purchase price, and a merchant name. In another embodiment, the transaction information 1308 may additionally include additional available credit. In other embodiments, less, more, or different information may be provided.

In the example illustrated, a payment date and fee options slider 1312 is shown. This is a linear graphic including at least an immediate payment date (i.e. same as purchase date) and a maximum payment date (12/4). The example shows five potential payment dates, identified as 11/6, 11/13, 11/20, 11/27, and 12/4. Each of the five payment dates shown has a corresponding transaction fee, with a $0 fee for the immediate 11/6 payment date and a $2.00 fee for the maximum 12/4 payment date. Depending on the factors previously discussed, payment times may have no transaction fee or a transaction fee, and later transaction fees for later payment times are the same or more than transaction fees for earlier payment times. In some embodiments, there may be a predetermined payment time as discussed with respect to FIG. 11, where payment times before the predetermined payment time have no transaction fee and payment times after the predetermined payment time have a transaction fee.

Associated with the payment date and fee options slider 1312 is a payment identification control 1316 which enables a consumer to select a specific payment time/transaction fee combination by moving the payment identification control 1316 to the desired selection. Other user interface embodiments known in the art may equivalently provide a payment identification control 1316 function, including but not limited to selecting an item from a dropdown list, selecting an item with a radio button, typing in a selected payment time, or rotating a dial.

In the embodiment illustrated, simply moving the payment identification control 1316 along the payment date and fee options slider 1312 does not select a payment processing time (payment date)/transaction fee combination. A consumer 124 may change their mind while moving the payment identification control 1316 or may accidentally move the payment identification control 1316 to a non-desired payment time/transaction fee combination. Once the consumer is satisfied the payment identification control 1316 position reflects the desired payment time/transaction fee combination, the consumer 124 activates the select control 1320, which selects the payment time and transaction fee identified by the payment identification control 1316 and transmits the selection to the credit server 116 or credit/banking server 116.

Referring now to FIG. 14, a diagram illustrating a User Interface Additional Offers Window 1132 in accordance with embodiments of the present invention is shown. Each of the fields and information shown may or may not be presented in other examples or presented in a similar fashion to that illustrated herein. The following description therefore applies to the illustrated example, and may or may not apply to other possible examples.

The user interface window is displayed on the client device 128 in response to the selected payment time 1124 not being greater than the predetermined payment time (i.e. the selected payment time 1124 is less than or equal to the predetermined payment time).

The additional offers window includes a page exit control 1304 to return the consumer 124 to the previous user interface window. One or more merchant offers 1404 are presented to the consumer 124, with a radio button construct providing an offer selection control 1408. In one embodiment, only one of all presented offers 1404 may be selected. In another embodiment, more than one presented offer 1404 may be selected. Finally, activation of a select control 1320 transmits selected presentation offers 1404 to the credit server 116, credit/banking server 116, or a merchant device 108 for further processing.

The descriptions and Figures included herein depict specific embodiments to teach those skilled in the art how to make and use the best option. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

Finally, those skilled in the art should appreciate that they can readily use the disclosed conception and specific embodiments as a basis for designing or modifying other structures for carrying out the same purposes of the present invention without departing from the spirit and scope of the invention as defined by the appended claims.

We claim:

1. A method comprising:
receiving, from a merchant device, information about a purchase transaction by a consumer;
calculating, by a credit server, a plurality of payment times comprising an immediate payment time and a later payment time;
transmitting, to a client device, the plurality of payment times;
selecting a payment time of the plurality of payment times;
receiving, by the credit server, the selected payment time;
scheduling, by the credit server, processing of the purchase transaction at the selected payment time; and
processing the purchase transaction at the selected payment time.

2. The method of claim 1, wherein prior to calculating the plurality of payment times, the method further comprising:
determining, by the credit server, that a payment time can be offered to the consumer.

3. The method of claim 2, wherein each of determining that a payment time can be offered to the consumer and calculating the plurality of payment times is based on one or more of a date, a pay-date of the consumer, wages earned for a time period, the consumer's credit rating, information about a consumer's transaction history with the merchant, information about a consumer's transaction history with a plurality of merchants, information about a particular purchase or sale, or information about any merchant-supported promotions.

4. The method of claim 3, wherein determining that a payment time can be offered to the consumer comprises:
determining, by the credit server, that a payment time can be offered for greater than none and less than all purchase transactions.

5. The method of claim 1, wherein the consumer uses a debit card to pay for the purchase transaction.

6. The method of claim 1, wherein one or more payment times of the plurality of payment times are associated with a corresponding transaction fee, wherein earlier payment times of the plurality of payment times are associated with a lower transaction fee than later payment times of the plurality of payment times.

7. The method of claim 6, wherein the client device comprises:
an application; and
a display screen;
wherein the application displays on the display screen information identifying the purchase transaction, the plurality of payment times, and for payment times associated with a corresponding transaction fee, the transaction fee,
wherein the application identifies on the display screen and transmits a selected payment time and corresponding transaction fee, if a transaction fee is applicable to the selected payment time,
wherein scheduling, by the credit server, processing of the purchase transaction at the selected payment time comprising:
scheduling a debit to a consumer account by a transaction amount of the purchase transaction and the selected transaction fee, if a transaction fee is applicable, and
wherein processing the purchase transaction at the selected payment time comprising:
debiting, by the credit server, a consumer account by the transaction amount of the purchase transaction and the selected transaction fee, if a transaction fee is applicable.

8. A system, comprising:
a network;
a merchant device, coupled to the network, configured to perform a purchase transaction for a consumer;
a credit server, coupled to the network, configured to:
receive information about the purchase transaction from the merchant device;
calculate a plurality of payment times comprising an immediate payment time and a maximum payment time;
transmit the plurality of payment times;
receive a selected payment time;
schedule processing of the purchase transaction at the selected payment time; and
process the purchase transaction at the selected payment time;
a client device, coupled to the network, configured to:
receive the plurality of payment times;
present the plurality of payment times to the consumer;
identify the selected payment time of the plurality of payment times; and
transmit the selected payment time.

9. The system of claim 8, wherein a banking server processes the purchase transaction at the selected payment time instead of the credit server.

10. The system of claim 8, wherein prior to the credit server calculates a plurality of payment times, the credit server determines that a non-immediate payment time can be offered to the consumer.

11. The system of claim 10, wherein each of the credit server determines that a payment time can be offered to the consumer and the credit server calculates the plurality of payment times is based on one or more of a date, a pay-date of the consumer, wages earned for a time period, the consumer's credit rating, information about a consumer's transaction history with the merchant, information about a consumer's transaction history with a plurality of merchants, information about a particular purchase or sale, or information about any merchant-supported promotions.

12. The system of claim 10, wherein the credit server determines that a payment time can be offered to the consumer for greater than none and less than all purchase transactions.

13. The system of claim 8, wherein the credit server is further configured to notify at least one of the merchant device and the client device of completed payment for the purchase transaction.

14. The system of claim 8, wherein the consumer uses a debit card to pay for the purchase transaction.

15. The system of claim 8, wherein one or more payment times of the plurality of payment times are associated with a corresponding transaction fee, wherein earlier payment times of the plurality of payment times are associated with a lower transaction fee than later payment times of the plurality of payment times.

16. The system of claim 15, wherein the client device comprises:
an application;
a display screen; and
a payment identification control,
wherein the application displays on the display screen information identifying the purchase transaction, the plurality of payment times, and for payment times associated with the corresponding transaction fee, the transaction fee,
wherein the application identifies and transmits a selected payment time and corresponding transaction fee, if a transaction fee is applicable to the selected payment time, with the payment identification control, wherein the selected transaction fee, if applicable, is uniquely associated with the selected payment time,
wherein the credit server schedules processing of the purchase transaction comprises the credit server schedules a debit to a consumer account by a transaction amount of the purchase transaction and the selected transaction fee, if a transaction fee is applicable, and
wherein the credit server processes the purchase transaction at the selected payment time comprises the credit server debits a consumer account by the transaction amount of the purchase transaction and the selected transaction fee, if a transaction fee is applicable.

17. A non-transitory computer readable storage medium configured to store instructions that when executed cause a processor to perform:
receiving, from a merchant device, information about a purchase transaction by a consumer, the information comprising at least a purchase amount and a purchase date;
calculating, by a credit server, a plurality of payment times comprising an immediate payment time and a later payment time;
transmitting, to a client device, the plurality of payment times;
selecting a payment time of the plurality of payment times;
receiving, by the credit server, the selected payment time;
scheduling processing of the purchase transaction at the selected payment time; and
processing the purchase transaction at the selected payment time.

18. The non-transitory computer readable storage medium of claim 17, wherein prior to calculating the plurality of payment times, the method further comprising:
determining, by the credit server, that a payment time can be offered to the consumer,
wherein each of determining that a payment time can be offered to the consumer and calculating the plurality of payment times is based on one or more of a date, a pay-date of the consumer, wages earned for a time period, the consumer's credit rating, information about a consumer's transaction history with the merchant, information about a consumer's transaction history with a plurality of merchants, information about a particular purchase or sale, or information about any merchant-supported promotions.

19. The non-transitory computer readable storage medium of claim 17, wherein one or more payment times of the plurality of payment times are associated with a corresponding transaction fee, wherein earlier payment times of the plurality of payment times are associated with a lower transaction fee than later payment times of the plurality of payment times.

20. The non-transitory computer readable storage medium of claim 19, wherein the client device comprises:
an application;
a display screen; and
a payment identification control,
wherein the application displays on the display screen information identifying the purchase transaction, the plurality of payment times, and for payment times associated with a corresponding transaction fee, the transaction fee,
wherein the application identifies and transmits a selected payment time and corresponding transaction fee, if a transaction fee is applicable to the selected payment time, with the payment identification control,
wherein scheduling processing of the purchase transaction at the selected payment time comprising:
scheduling, by the credit server, a debit to a consumer account by a transaction amount of the purchase transaction and the selected transaction fee, if a transaction fee is applicable, and
wherein processing the purchase transaction at the selected payment time comprising:
debiting, by the credit server, a consumer account by the transaction amount of the purchase transaction and the selected transaction fee, if a transaction fee is applicable.
